(19) United States
(12) Patent Application Publication
(10) Pub. No.: US 2025/0050283 A1
(43) Pub. Date: Feb. 13, 2025

(54) HOLLOW MICROSPHERES FOR BIOLOGICAL ISOLATION AND RECOVERY

(71) Applicant: Texas Tech University System, Lubbock, TX (US)

(72) Inventors: Wei LI, Lubbock, TX (US); Rutwik JOSHI, Lubbock, TX (US); Gizem LEVENT, Bryan, TX (US)

(21) Appl. No.: 18/930,686

(22) Filed: Oct. 29, 2024

Related U.S. Application Data
(63) Continuation-in-part of application No. 17/285,884, filed on Apr. 15, 2021.
(60) Provisional application No. 62/747,487, filed on Oct. 18, 2018.

(51) Int. Cl. B01D 71/04; B01D 67/00; C01B 3/00; C01B 3/50; C03B 19/10; C03C 11/00

(52) U.S. Cl. CPC B01D 71/04; B01D 67/0058; C01B 3/0026; C01B 3/0084; C01B 3/503; C03B 19/1075; C03C 11/002; C01B 2203/0405

(57) ABSTRACT

Hollow glass microspheres (HGMS) with a controlled nanotopographical surface structure (NSHGMS) demonstrate improved isolation and recovery of cells and other biological particles such as bacteria from biological fluid. Such functionalized HGMS are formed by exposing a plurality of hollow glass microspheres to a layer by layer deposition cycle of charged polymeric nanofilms to form a plurality of coated hollow glass microspheres and functionally binding a plurality of biotinylated antibodies to the plurality of coated hollow glass microspheres. Application of these HGMS in related biological particle isolation methods does not require specialized lab equipment or an external power source, and thus, can be used for separation of targeted cells from blood or other fluid in a resource-limited environment.

### CROSS REFERENCE TO RELATED PATENT APPLICATIONS

This patent application is a continuation in part of U.S. patent application Ser. No. 17/285,884, titled, “RAPID CELL ISOLATION AND RECOVERY USING HOLLOW GLASS MICROSPHERES COATED WITH BIODEGRADABLE NANOSTRUCTURED FILMS”, which was filed on Apr. 15, 2021. U.S. patent application Ser. No. 17/285,884 is herein incorporated by reference in its entirety.

U.S. patent application Ser. No. 17/285,884 is a US National Stage Application under 35 U.S.C. § 371 of international Application Number PCT/IB2019/058916, titled, “RAPID CELL ISOLATION AND RECOVERY USING HOLLOW GLASS MICROSPHERES COATED WITH BIODEGRADABLE NANOSTRUCTURED FILMS” which was filed on Oct. 18, 2019.

U.S. patent application Ser. No. 17/285,884, international Application Number PCT/IB2019/058916, and this application claim the priority and benefit under 35 U.S.C. § 119 (e) of U.S. Provisional Patent Application Ser. No. 62/747,487 filed Oct. 18, 2018, entitled “RAPID CELL ISOLATION AND RECOVERY USING HOLLOW GLASS MICROSPHERES COATED WITH BIODEGRADABLE NANOSTRUCTURED FILMS.” U.S. Provisional Patent Application Ser. No. 62/747,487 is herein incorporated by reference in its entirety.

### TECHNICAL FIELD

The present embodiments are generally related to cell isolation techniques. More particularly, embodiments are related to the application and use of topographical surface coated hollow glass microspheres to enhance the likelihood of capturing cells or bacteria in fluid using the hollow glass microspheres. Embodiments are further related to bacteria isolation techniques. Embodiments are also related to the manufacture and use of hollow microspheres with coatings configured to capture and isolate bacteria.

### BACKGROUND

Established cell isolation and purification techniques such as fluorescence activated cell sorting (FACS), isolation through magnetic micro/nanoparticles, and recovery via microfluidic devices are incredibly useful tools. However, known methods for cell or bacterial isolation are limited with respect to point-of-care use in remote areas where lab equipment as well as electrical, magnetic, and optical sources are restricted. Most standard approaches involve sophisticated microfabrication, excessive lab equipment, long processing times, and significant labor, which limit the practicality of their use, particularly in resource-limited settings.

To develop and employ a reliable method for cell/bacterial isolation in a resource-limited settings, the following issues need to be addressed. First, the isolated cells should have high viability. Second, the phenotype of the cells should be well preserved for downstream studies. Samples should not be exposed to stresses that are known to affect cell phenotype, including high shear forces, harmful reagents, and non-physiological temperatures and PH levels. Further, any employed method should achieve both high efficiency of cell recovery and cell purity. Non-specific retention of untargeted cells needs to be diminished. Finally, the approach should be feasible for disposable point-of-care use even in remote areas with minimal access to sophisticated lab equipment and complex electrical, magnetic, or optical sources.

For example, microfluidic devices are widely used for CTC isolation, owing to the precise fluidic manipulation coupled with high surface-to-volume ratio. Generally, blood samples continuously flow at a relatively low flow rate through microfluidic devices; there, antibodies modified on channel surface can collect CTCs, and blood cells are allowed to pass. As an alternative to microfluidic devices, immunomicro/nano-bead-based CTC isolation methods are relatively simple for both production and application. For example, CellSearch™ is the first and only FDA approved product for CTC application, where CTCs are attached with antibody-conjugated nanomagnetic particles, and separated by a magnetic field. However, this approach requires large quantity of magnetic nanoparticles in cell isolation, which could compromise the purity of enriched cells. Further, viability of the isolated CTCs drops due to internalization of magnetic nanoparticles. Although larger microparticles could be used to enhance cell viability, it was found that beads with sizes larger than six microns are less effective in capturing cancer cells due to the beads lower surface area.

Salmonella enterica is a one of the major foodborne pathogens in the United States. Timely isolation, recovery, and identification of Salmonella from food samples is essential for prevention and control of foodborne Salmonella outbreaks. Traditional culture-based Salmonella isolation and serotyping techniques are time consuming and labor intensive. Despite the existence of innovative rapid bacterial isolation techniques like microfluidics and immunomagnetic nanoparticles, these methods often require sophisticated lab equipment and tedious microfabrication.

Microspheres (also referred to as “microbubbles”) covered with cell specific antibodies have been used for the isolation of specific cells or other biologic particles within a fluid (e.g., blood). However, the smooth surface of the microspheres reduces their capture efficacy. As such, there is a need for improved methods and systems for biological particle capture that improve the capture of cells or other biologic particles in fluid using microspheres.

The present embodiments introduce a process and associated materials that can create a topographical surface on the microspheres and thereby alter the smooth surface of the microspheres in order to significantly increase capture effectiveness, especially where concentrations of cells in a sample may be very low. Self-floating hollow glass microspheres with a nanostructured surface can isolate and recover circulating tumor cells in blood (and other cells in other body fluids) with shorter processing time, enhanced capture efficiency and lower detection limit. In addition, hollow glass microspheres coated with layer-by-layer (LbL) nanostructured polymeric films and conjugated anti-bacterial antibodies can be used for rapid isolation and recovery of bacteria such as Salmonella.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

In accordance with a feature of the embodiments, a topographical structure is added to the surface of a bead representing the microsphere to create a non-smooth surface using a nanostructure (NSHGMS). The introduction of the topographical structures allows for an increased surface area that will allow for more antibodies to come in contact with the desired cells.

It is a feature to provide a method for providing rapid cell isolation and recovery that includes providing hollow glass microspheres coated with a biodegradable nanostructured film within a fluid, and then using the coated microspheres for the isolation and recovery of cells or other biological particles, including but not limited to bacteria, on the nanostructured film from fluid using the microspheres, in accordance with the embodiments.

It is a feature to provide glass microspheres with an added topographical structure to make the surface of the microspheres non-smooth. This can be accomplished using a nanostructure (nsHGMS). The introduction of the topographical structures allow for an increased surface area that will allow for more antibodies to come in contact with the desired cells or biological particles.

It is also a features to provide hollow glass microspheres with surface cracks and/or surface imperfections to increase the surface area of the microspheres, thus improving the number of binding sites and binding affinity.

It is another feature to provide hollow glass microspheres coated with a biodegradable nanostructured film for use in the isolation and recovery of cells in fluid, wherein the nanostructured film further comprises negatively charged SiO₂ nanoparticles and positively charged poly-L-arginine molecules applied to a surface of the hollow glass microspheres, in accordance with the embodiments.

It is another feature to provide hollow glass microspheres coated with a biodegradable nanostructured film for use in the isolation and recovery of cells in fluid, wherein the negatively charged SiO₂ nanoparticles and positively charged poly-L-arginine molecules are applied to the surface of the hollow glass microspheres using layer-by-layer deposition, in accordance with the embodiments.

It is yet another feature to provide hollow glass microspheres coated with a biodegradable nanostructured film for use in the isolation and recovery of cells in fluid, wherein the surface of the hollow glass microspheres including the negatively charged SiO₂ nanoparticles and positively charged poly-L-arginine molecules is then sheathed with an enzymatically degradable LbL film made from biotinylated alginate and poly-L-arginine, in accordance with the embodiments.

It is a feature to provide microspheres coated with biodegradable nanostructured film for use in the isolation and recovery of cells in fluid, wherein negatively charged SiO₂ nanoparticles, positively charged poly-L-arginine molecules, and enzymatically degradable LbL film made from biotinylated alginate and poly-L-arginine, are applied to the surface of the hollow glass microspheres using layer-by-layer deposition, in accordance with the embodiments.

It is another feature to provide hollow glass microspheres coated with a biodegradable nanostructured film for use in the isolation and recovery of cells in fluid, wherein negatively charged SiO₂ nanoparticles and positively charged poly-L-arginine molecules covering microspheres are sheathed with an enzymatically degradable LbL film made from biotinylated alginate and poly-L-arginine and then are capped with anti-EpCAM antibodies and anti-fouling PEG molecules, in accordance with the embodiments.

It is another feature to provide hollow glass microspheres coated with a biodegradable nanostructured film for use in the isolation and recovery of cells in fluid, wherein negatively charged SiO₂ nanoparticles, positively charged poly-L-arginine molecules, enzymatically degradable LbL film made from biotinylated alginate and poly-L-arginine, and a cap of anti-EpCAM antibodies and anti-fouling PEG molecules are each applied to the surface of the hollow glass microspheres using layer-by-layer deposition, in accordance with the embodiments.

It is also a feature to provide hollow glass microspheres coated with a biodegradable nanostructured film for use in the isolation and recovery of cells in fluid that are effective for rapid cell isolation and recovery using layer-by-layer (LbL) application of negatively charged SiO₂ nanoparticles and positively charged poly-L-arginine molecules to a surface of hollow glass microspheres, in accordance with the embodiments.

It is a feature to provide a cell isolation and recovery microstructure system including microspheres coated with a biodegradable nanostructure film applied to the microspheres via layer-by-layer deposition, wherein the microstructure system isolates and recovers cells in accordance with the embodiments.

It is a feature to provide a cell isolation and recovery microstructure system including microspheres coated with a biodegradable nanostructure film applied to the microspheres via layer-by-layer deposition, wherein the biodegradable nanostructure film further comprises negatively charged SiO₂ nanoparticles and positively charged poly-L-arginine molecules applied to a surface of the hollow glass microspheres, in accordance with the embodiments.

It is a feature to provide a cell isolation and recovery microstructure system including microspheres coated with a biodegradable nanostructure film applied to the microspheres via layer-by-layer deposition, wherein the surface of the hollow glass microspheres including the negatively charged SiO₂ nanoparticles and positively charged poly-L-arginine molecules can include a sheathing of enzymatically degradable LbL film made from biotinylated alginate and poly-L-arginine, in accordance with the embodiments.

It is a feature to provide a cell isolation and recovery microstructure system including microspheres coated with a biodegradable nanostructure film applied to the microspheres via layer-by-layer deposition, wherein the surface of the hollow glass microspheres including the negatively charged SiO₂ nanoparticles and positively charged poly-L-arginine molecules sheathed with enzymatically degradable LbL film made from biotinylated alginate and poly-L-arginine further comprises a cap of anti-EpCAM antibodies and anti-fouling PEG molecules, in accordance with the embodiments.

An aspect of the disclosed embodiments includes a method for capturing and separating biological particles comprising exposing a plurality of functionalized microspheres to a fluidic sample with a suspected biological particle, capturing biological particles on the functionalized microspheres, removing the functionalized microspheres from the fluidic sample, and releasing the captured biological particles from the functionalized microspheres. The functionalized microspheres comprise hollow glass microspheres coated with at least two layers of charged polymeric nanofilms and a plurality of biotinylated antibodies operably connected to an outer layer of the at least two layers of charged polymeric nanofilm. One of the at least two layers of polymeric nanofilm comprises negatively charged biotin modified alginate and one of the at least two layers of polymeric nanofilm comprises positively charged Polydiallyldimethylammonium chloride. In an embodiment, the suspected biological particle comprises a suspected bacterial contaminant. In an embodiment, the biotinylated antibodies are antibodies for the suspected bacterial contaminant. In an embodiment, releasing the biological particle from the functionalized microspheres comprises exposing the functionalized microspheres with the captured biological particles to an enzyme selected to degrade the polymeric nanofilm. In an embodiment, the enzyme comprises alginate lyase. The method can include collecting the released biological particle after releasing the captured biological particle from the functionalized microspheres. In an embodiment, the method includes identifying the released biological particle after releasing the captured biological particle from the functionalized microspheres.

An aspect of the disclosed embodiments includes a system for capturing and separating biological particles comprising a plurality of microspheres, at least two layers of polymeric nanofilm deposited on each of the plurality of microspheres, the first layer of the at least two layers of polymeric nanofilm comprising a coating of positively charged polymeric nanofilm; and the next layer of the at least two layers of polymeric nanofilm comprising a coating of negatively charged polymeric nanofilm, and a plurality of biotinylated antibodies functionally bound to an outer layer of the at least two layers of polymeric nanofilm. In an embodiment, the coating of positively charged polymeric nanofilm comprises positively charged Polydiallyldimethylammonium chloride. In an embodiment, the coating of negatively charged polymeric nanofilm comprises negatively charged biotin modified alginate. In an embodiment, the plurality of biotinylated antibodies are antibodies for a suspected bacterial contaminant. In an embodiment, the system further comprises an enzyme configured to degrade the polymeric nanofilm deposited on each of the plurality of microspheres. In an embodiment the enzyme comprises alginate lyase. In an embodiment, each of the plurality of microspheres comprise a negatively charged hollow glass microspheres.

An aspect of the disclosed embodiments includes a method of making a system for capturing and separating biological particles comprising exposing a plurality of hollow glass microspheres to a layer by layer deposition cycle of charged polymeric nanofilms to form a plurality of coated hollow glass microspheres and functionally binding a plurality of biotinylated antibodies to the plurality of coated hollow glass microspheres. In an embodiment the layer by layer deposition cycle of charged polymeric nanofilms comprises exposing the plurality of hollow glass microspheres to a positively charged Polydiallyldimethylammonium chloride, washing the plurality of hollow glass microspheres, exposing the plurality of hollow glass microspheres to a negatively charged biotin modified alginate, and washing the hollow glass microspheres. The layer by layer deposition cycle of charged polymeric nanofilms further comprises exposing the plurality of hollow glass microspheres to the first positively charged Polydiallyldimethylammonium chloride for at least 10 minutes and exposing the plurality of hollow glass microspheres to all subsequent layers of the charged polymeric nanofilms for at least 5 minutes. In an embodiment, the plurality of biotinylated antibodies comprise antibodies for a suspected bacterial contaminant.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates a flow diagram of a process for making a coated hollow microsphere, in accordance with the disclosed embodiments;

FIG. 2 illustrates a material and fabrication process associated with hollow glass microspheres with nanotopographical structures (NSHGMS), in accordance with the disclosed embodiments;

FIG. 3 illustrates SEM images of NSHGMS with zero to 200 nm of SiO₂, in accordance with the disclosed embodiments;

FIG. 4 illustrates charts showing graphical representations of data collected while monitoring an LbL deposition process of NSHGMS, in accordance with the disclosed embodiments;

FIG. 5 illustrates fluorescence images and cross-sectional intensity profiles of LbL film on the outmost surface of NSHGMS before and after degradation by ALG lyase, together with SEM images of surface morphologies of NSHGMS before and after degradation by ALG lyase, in accordance with the disclosed embodiments;

FIG. 6 illustrates a digital image of floating NSHGMS and separated blood cells in a testing tube, and fluorescence images of captured MCF-7 cells, with the MCF-7 cells stained by CellTracker™ Deep Red, and capture efficiency of NSHGMS covered with SiO₂ NPs with different sizes, in accordance with the disclosed embodiments;

FIG. 7 illustrates a series of graphs showing capture efficiency of NSHGMS and regular HGMS at different incubation times, capture efficiency of NSHGMS and regular HGMS with respect to various spiked cell concentrations (cell/mL), and (c) capture efficiency of NSHGMS and regular HGMS for different cancer cell lines (1,000 cells/mL), in accordance with the disclosed embodiments;

FIG. 8 illustrates a graphical illustration of release efficiency and viability of released cancer cells from NSHGMS, next to images of live (green)/Dead (red) staining of captured and released MCF7 cells, where the MCF7 cells were pre-stained with CellTracker™ Deep Red before spiking into blood (1000 cells/mL), where live MCF7 cells show co-localization of pink and green fluorescent signals, in accordance with the disclosed embodiments;

FIG. 9 illustrates a high level method for separating and recovering biological particles using functionalized hollow glass microspheres, in accordance with the disclosed embodiments;

FIG. 10 illustrates a material and fabrication process associated with functionalized hollow glass microspheres, in accordance with the disclosed embodiments;

FIG. 11 illustrates steps associated with an exemplary method for preparing a sample for separation and recovery of biological particles therein using functionalized hollow glass microspheres, in accordance with the disclosed embodiments;

FIG. 12A illustrates a chart showing capture efficiency in Salmonella spiked beef extract using the disclosed functionalized HGMS, according to the methods disclosed herein;

FIG. 12B illustrates chart showing capture efficiency in Salmonella spiked cantaloupe using the disclosed functionalized HGMS, according to the methods disclosed herein;

FIG. 12C illustrates a chart showing capture efficiency in Salmonella spiked lysed blood with and without a PEG antifouling layer, according to the methods disclosed herein;

FIG. 13 illustrates an image of colony formation of recovered Salmonella with and without antibody functionalization, in accordance with the disclosed embodiments;

FIG. 14 illustrates an SEM image of a pseudo-colored Salmonella captured on the disclosed functionalized HGMS surface, in accordance with the disclosed embodiments; and

FIG. 15 illustrates a testing system incorporating functionalized HGMS, in accordance with the disclosed embodiments.

### DETAILED DESCRIPTION

The particular values and configurations discussed in the following non-limiting examples can be varied and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims. As used herein the phrase biological particle can refer to a cell, bacteria, or other such biological particle.

The embodiments disclosed herein are directed to self-floating hollow glass microspheres (HGMS) coated with layer-by-layer (LbL) nanostructured polymeric films and conjugated anti-bacterial antibodies which can be used for rapid isolation and recovery of bacteria such as Salmonella. The disclosed embodiments provide the ability to isolate bacteria in as little as 2 hours offering significant advantages over complex and time consuming prior approaches.

The disclosed technology relates tangentially to the biomedical research industry. Biomedical research encompasses all research that is done to further the field of science. Cell isolation is used in almost every lab to conduct in vitro studies. The disclosed technology has the potential to be used as a cheap and effective cell sorting method. The disclosed technology also has value in the in vitro diagnostics market. The disclosed technology will offer a simple and cheap method for testing patients' blood for certain cells that could be markers for cancer and other diseases.

Personalized medicine requires isolation of targeted cells with high purity, high viability, and high specificity. Easy processing and minimal sample preparation are also preferred in this field. The disclosed embodiments can be used, for example, in a surgical room, to achieve fast isolation of targeted cells for downstream molecular analysis, and associated development of a personalized disease model. The embodiments can also be applied to the isolation of T-cells for immunotherapy, and for the rapid identification of bacterial contamination.

Microspheres or microbubbles are hollow and therefore naturally buoyant. As such, they can be used effectively for cell isolation in fluid. Adding SiO₂ nanoparticles to the surface of microspheres can produce a topographical or rough surface on the microspheres. This coating provides increased surface area on the microspheres that contain antibodies and can create valleys or crevasses in the sphere surface that can allow for multiple antibodies to potentially grab onto the targeted cells. This improvement allows for a significantly more effective method of cell isolation. Glass microspheres with an added topographical structure make the surface of the microspheres non-smooth. This can be accomplished using a nanostructure (nsHGMS). The introduction of the topographical structures allows for an increased surface area that will allow for more antibodies to come in contact with the desired cells. It can also be a feature to provide hollow glass microspheres with surface cracks and/or surface imperfections, to increase the surface area of the microspheres, thus improving the number of binding sites and binding affinity.

Embodiments are directed to methods, structures, and systems for achieving cell (or bacterial) isolation that require neither specialized lab equipment nor any external power source. The embodiments are directed to self-floating hollow glass microspheres (HGMSs) coated with an enzymatic degradable thin film and conjugated with antibodies to allow both fast capture and release of subpopulations of cells or other biological particles, from a fluidic suspension with cells or biological particles therein. Cell capture is mediated by the interactions between antibodies on the surface of HGMSs and surface markers on the targeted cells. Captured cells bound to the hollow glass microspheres naturally float to the top of the hosting liquid and separate from the untargeted cells.

For isolation of bacteria, which are typically much smaller than cells, bacteria targeting nanoparticles are introduced into the cell mixture first, followed by the addition of nanoparticle-targeting hollow glass microspheres; the subsequent capture interaction is similar to the cell capture explained above. The cells are then recovered by degrading the link between the cells and the HGMSs.

As an example, circulating tumor cells (CTCs), derived from primary tumor sites, can travel through the bloodstream to distant organs, causing metastasis and cancer-related death. Therefore, isolation and analysis of CTCs in peripheral blood, (liquid biopsy), has attracted attention because it can be used for cancer prognosis and allow personalized treatment for cancer patients. However, it is still a challenge to capture CTCs effectively with high purity due to their rarity (1-100 in 109 blood cells). By taking advantage of specific cancer cell surface markers, such as the epithelial cell adhesion molecule (EpCAM), CTCs can be isolated by maximizing the adhesion of CTCs with antibody-modified surface.

Recent studies indicate that nanotopography of the substrates underneath the antibody molecules has a significant effect on CTC adhesion. Microchips with inner surfaces modified with nanostructures (such as nanopillars, nanodots, nanofibers, and nanofractals) showed enhanced capture performance. Recently, self-floating hollow glass microspheres (HGMS) modified with tumor-specific antibodies have been developed in accordance with the disclosed embodiments, for capture of CTCs in resource-limited settings; these HGMSs demonstrate effective cell isolation and good viability of isolated cancer cells when the concentration of spiked cells is larger than several thousand per milliliter. Capture efficiency, however, dramatically decreases if the spiked cell concentration in blood is below 1000 cells/mL, probably due to insufficient interactions between cancer cells and the HGMS surface. In order to apply the HGMS approach for CTC isolation to clinically relevant samples with concentrations from a few to several hundred cells/mL, it is clear that it is desirable to create nanostructures on the HGMS surface and enhance cell-surface interactions as disclosed herein. Nonetheless, current microfabrication methods for generating nanostructured surface (i.e., chemical etching, chemical vapor deposition, electrochemical deposition, or electrospinning) are not feasible for surface coating of microparticles.

Self-floating hollow glass microspheres (HGMS) modified with tumor-specific antibodies as disclosed herein can be used for capture of circulating tumor cells (CTCs), and are effective for cell isolation while maintaining good viability of isolated cancer cells. The present inventors have discovered that the capture efficiency, however, can decrease dramatically if the spiked cell concentration is low, possibly due to insufficient interactions between cells and the HGMS' surface. In order to apply an HGMS-based, CTC isolation to clinically relevant samples, the present inventors have determined that it is desirable to create nanostructures on the surface of HGMS to enhance cell-surface interactions. Current microfabrication methods, however, cannot generate nanostructured surface on the microspheres.

To address the shortcomings of microfabrication capabilities, embodiments disclosed herein are directed to a new HGMS with controlled nanotopographical surface structure (herein referred to as “NsHGMS”), and have demonstrated isolation and recovery of rare cancer cells utilizing the new HGMS with controlled nanotopographical surface structure. Using cancer cells as an example, NSHGMS reveal shorter isolation time (20 min.), enhanced capture efficiency (93.6±4.9%) and lower detection limit (30 cells/mL) for commonly used cancer cell lines (MCF7, SK-BR-3, PC-3, A549 and CCRF-CEM) as compared to smooth-surfaced HGMS. As a further benefit, this NSHGMS-based CTC isolation method does not require specialized lab equipment or an external power source, and thus, can be used for separation of targeted cells from blood or other body fluid in a resource-limited environment.

Layer-by-layer (LbL) assembly is a versatile technique for surface modification, which is not limited by the shape of substrates (planar and particulate substrates) or materials for deposition (polymers, proteins, lipids, nucleic acids, and nanoparticles). Generally, electrostatic interaction is the most common driving force for LbL assembly, where positively and negatively charged macromolecules are adsorbed onto substrates alternatively, allowing the incorporation of electronically charged species. Metal and polymer nanoparticles can also be used as building blocks and can be successfully embedded in the LbL films for applications in drug delivery, optical devices, and batteries.

NSHGMS can be achieved by applying layer-by-layer (LbL) assembly of negatively charged SiO₂ nanoparticles (NPs) and positively charged poly-L-arginine molecules. The surface is then sheathed with an enzymatically degradable LbL film made from biotinylated alginate and poly-L-arginine, and capped with anti-EpCAM antibodies and anti-fouling molecules. Compared to HGMS with a smooth surface, NSHGMS has a shorter isolation time (20 min.), enhanced capture efficiency (93.6±4.9%) and lower detection limit (30 cells/mL) for many cancer cell lines (MCF7, SK-BR-3, PC3, A549, CCRF-CEM). The NSHGMS-based CTC isolation method does not require specialized lab equipment or an external power source, making it possible to rapidly perform separation of targeted cells from blood or other body fluids in a surgical room or other resource-limited environments.

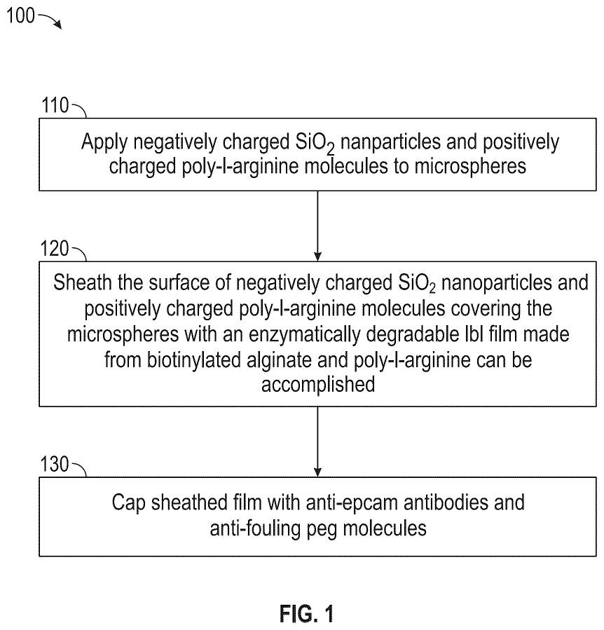

Referring to FIG. 1, the disclosed embodiments are directed to an NSHGMS which can be fabricated by applying layer-by-layer (LbL) assembly of negatively charged SiO₂ nanoparticles and positively charged poly-L-arginine molecules to microspheres as shown in step 110. Then as shown in step 120, the surface of negatively charged SiO₂ nanoparticles and positively charged poly-L-arginine molecules covering the microspheres is sheathed with an enzymatically degradable LbL film made from biotinylated alginate and poly-L-arginine. Then, as shown in step 130, the resulting film as sheathed, can be capped with anti-EpCAM antibodies and anti-fouling PEG molecules.

During an experiment, Alginate (ALG) (Pronova UPMVG, 60% guluronate, 40% mannuronate, Mw=120,000) was acquired from Novamatrix, Norway. Poly-L-arginine (PARG, Mw=15,000-70,000) was acquired from Sigma-Aldrich and used without further purification. Poly(ethylene glycol) 2-aminoethyl ether biotin (NH2-PEG-biotin, Mw=20,000) (PEG20 000) was acquired from Nanocs Inc. Neutravidin (Mw=60,000), NeutrAvidin-Texas Red conjugate (A-2665), 1-ethyl-3-(-3-dimethylaminopropyl) carbodiimide hydrochloride (EDC), and N-hydroxysulfosuccinimide (Sulfo-NHS) were acquired from ThermoFisher Scientific. Biotin conjugated EpCAM (CD326) monoclonal antibody was provided by Fisher Scientific. Biotin conjugated mouse antihuman CD71 was obtained from BD Bioscience. Alginate Lyase (A1603) was acquired from Sigma Aldrich. Blood from healthy donors was purchased from BioreclamationIVT (Westbury, N.Y.) and used within 3 days of collection. Hollow glass microspheres (HGMS, density=0.47 g/mL and diameter range of 20-27 μm) were obtained from Cospheric LLC. Silica nanoparticles (SiO₂ NPs) (with nm size of 20, 40, 80, 120, and 200) were acquired from General Engineering & Research. All other reagents were acquired from Sigma Aldrich, USA, and used as received.

Alginate was modified with biotin hydrazide (Sigma B7639) using a standard EDC reaction. Briefly, 2-ethanesulfonic acid (MES) buffer (pH=6.1) was used to prepare 1.0 wt % of ALG solution. Then 0.16 wt. % biotin hydrazide, 0.72 wt. % EDC, and 0.41 wt. % Sulfo-NHS were added to the ALG solution and reacted for 3 hours. Then the solution was dialyzed against deionized H2O for 48 hours and lyophilized to recover biotin modified alginate (BALG).

PARG and BALG were dissolved in deionized water (DI water) at a concentration of 2 mg/mL. SiO₂ NPs were dispersed in DI water to prepare a 10 wt. % suspension. The LbL deposition process involves the repeated sequential incubation of HGMS into aqueous solutions of positively and negatively charged materials, with a washing step in between. PARG and SiO₂ NP solutions were first used to modify HGMS surface. After two cycles of deposition, PARG and BALG solutions were used to form two bilayers of LbL film.

LbL film assembly was examined by a quartz-crystal microbalance with dissipation monitoring (QCM-D) (Q-Sense, E4 model, Sweden) and recorded at different overtones (n=3rd, 5th, 7th, 9th, 11th and 13th). SiO₂ QCM-D (Q-sense, QSX 303) crystals were used as substrates and cleaned by a plasma cleaner for 5 minutes before experiment. To monitor LbL film adsorption process, PARG and SiO₂ NP solutions were introduced into the QCM-D flow cell for 5 min with 5 min rinse steps in between. After two repeats of deposition, PARG and BALG solutions were pumped in the QCM-D flow cell to perform another two cycles of adsorption according to the previous protocol. The flow rate for all liquids was 0.15 mL/min.

The QCM-D results were analyzed with QTools (version: 3.1.30.624) to estimate adsorption mass based on the Voigt-based model as follows:

$$\begin{matrix}Δ F \approx - \frac{1}{2 {πρ}_{0} {h}_{0}} \{ \frac{{η}_{3}}{{δ}_{3}} + {\sum }_{j = k} [ {h}_{j} {ρ}_{j} ω - 2 {{h}_{j} ( \frac{{η}_{3}}{{δ}_{3}} )}^{2} \frac{{η}_{j} {ω}^{2}}{{μ}_{j}^{2} + {ω}^{2} {η}_{j}^{2}} ] \} \\ Δ D \approx \frac{1}{2 {πρ}_{0} {h}_{0}} \{ \frac{{η}_{3}}{{δ}_{3}} + {\sum }_{j = k} [ 2 {h}_{j} {( \frac{{η}_{3}}{{δ}_{3}} )}^{2} \frac{{η}_{j} ω}{{μ}_{j}^{2} + {ω}^{2} {η}_{j}^{2}} ] \}\end{matrix}$$

where, for a total of k viscoelastic layers under a bulk Newtonian fluid, p₀ and h₀ are the density and thickness of the quartz crystal, η₃ is the viscosity of the bulk fluid, δ3 is the viscous penetration depth of the shear wave in the bulk fluid, p₃ is the density of liquid, μ is the elastic shear modulus of an overall layer, and co is the angular frequency of the oscillation. 0.0088 Pas was assumed as liquid viscosity. 1010 kg·m⁻³, 1050 kg·m⁻³ and 2650 kg·m⁻³ were used to estimate liquid, polymer film and SiO₂ densities. Calculation used six overtones: 3rd, 5th, 7th, 9th, 11th and 13^{th.}

A human breast cancer cell line, MCF7 (ATCC HTB-22), was cultured at 37° C. in DMEM medium containing 10% fetal bovine serum (FBS) and 1% penicillin/streptomycin. A human breast cancer cell line, SK-BR-3 (ATCC HTB-30), was cultured at 37° C. in RPMI-1640 medium containing 10% fetal bovine serum (FBS) and 1% penicillin/streptomycin. A human prostate cancer cell line, PC-3 (ATCC CRL-1453), and a human lung cancer cell line, A549 (ATCC CCL-185), were cultured at 37° C. in F-12K growth medium containing 10% FBS and 1% penicillin/streptomycin. A human T lymphoblast cell line, CCRF-CEM (ATCC CRM-CCL-119), was cultured in RPMI-1640 medium with 10% fetal bovine serum (FBS) and 1% penicillin/streptomycin. Adhesion cells were released from culture flasks through incubation in 0.25% trypsin-EDTA (Invitrogen, CA) at room temperature for 5 min. Prior to spiking into blood, all cells were labeled with a fluorescent cellular dye (CellTracker™ Deep Red or CellTracker™ Blue, ThermoFisher) following the manufacturers' protocol. The cell suspension was subsequently constructed to the desired concentration in 5× diluted blood. Concentration of cancer cells in the suspension ranged from 30 cells/mL to 1,000 cells/mL.

After modifying the surface with SiO₂ NPs and PARG/BALG film, the coated HGMS were incubated with a Neutravidin solution (0.05 mg/mL) for 1 h. After washing by PBS, a mixture solution (20 μg/mL biotinylated anti-EpCAM and 20 μg/mL NH2-PEG-Biotin) was employed to coat EpCAM antibody and PEG molecules on the surface of Neutravidin functionalized NsHGMS.

For cell isolation, the NSHGMS and cancer cells spiked diluted blood were mixed on a rotator at 10 rpm for 60 min at room temperature. After incubation, the HGMS were carefully harvested and incubated with 100 μL ACK lysing buffer (ThermoFisher Scientific A1049201) in a polydimethylsiloxane (PDMS) micro-well. The uncaptured blood was transferred into a 96-well plate where red blood cells were lysed by adding 200 μL ACK lysing buffer to each well. The numbers of depleted and captured cancer cells were quantified using an optical microscope (Olympus BX53). To release captured cancer cells, the top layer of PARG/BALG film was degraded by adding alginate lyase (100 μL at 1 mg/mL) for 10 minutes. Capture efficiency and captured cells purity are defined as follows:

$$Capture efficiency = \frac{Number of captured cancer cells}{Total number of spiked cancer cells}$$

$$Purity of captured cells = \frac{Number of captured cancer cells}{Total number of captured cancer cells and blood cells}$$

Fluorescent images were taken with an EVOS FL microscope (Life Technologies). DAPI, GFP, Texas Red and Deep Red images were taken at nm wavelengths of 345, 488, 530, and 630, respectively.

The viability of recovered cancer cells was evaluated with a standard Live/Dead fluorescent assay (Life Technologies L3224) using manufacture's standard protocol and compared with control cells that had not been processed with NSHGMS.

Hollow glass microspheres were characterized by scanning electron microscopy (SEM, Hitachi S-4300, Japan) at 5 kV. Cells were fixed by 2% glutaraldehyde in PBS solution for 12 h. NSHGMS were washed by DI water. All samples were gradually rinsed with 20%, 40%, 60%, 80% and 100% ethanol, and dried at room temperature for 12 hours. The dried samples were gold-coated by a sputter and scanned under SEM at 300×, 1000×, 2500× and 50000× magnifications.

Data analysis was performed between groups using one-way ANOVA (n=3) by software Graphpad Prism 6.0. Calculated probabilities of p<0.0001, 0.0001<p<0.001, 0.001<p<0.01, 0.01<p<0.05 and p>0.05 were represented by ****, ***, **, * and N.S., respectively.

HGMS with smooth surfaces have been developed for capturing CTCs and have demonstrated effective cell isolation and good viability of isolated cancer cells. However, CTC capture was not efficient when the spiked cell concentration in blood is below several thousand per milliliter of blood, possibly due to insufficient interactions between cancer cells and HGMS' surface. In order to improve performance for CTC isolation for clinical patient samples (normally in the range of a few to several hundred cells per mL), a potential strategy is to enhance cell-surface interaction by creating nanotopographical structures on the HGMS' surface. The LbL deposition process was used to construct both nanostructures and biodegradable coating on the surface of HGMS. To build nanostructures on HGMS, SiO₂ NPs were chosen because they are chemically inert, physically robust and intrinsically negatively charged. To compensate the charge, poly-Larginine (PARG) was selected as the positively charged building block; this was used in previous work and showed good biocompatibility. Taking advantage of the flexibility of charged materials that are introduced during each deposition, alginate (ALG) was selected as another negatively charged component to form a layer of nanofilm coating on the SiO₂ nanostructures. ALG can easily conjugate with biotin molecules for further modification of the surface with antibodies to capture cancer cells. Further, PARG/ALG film can be rapidly enzymatically degraded in a mild condition, which provides a noninvasive way to quickly release capture cells and preserve high cell viability.

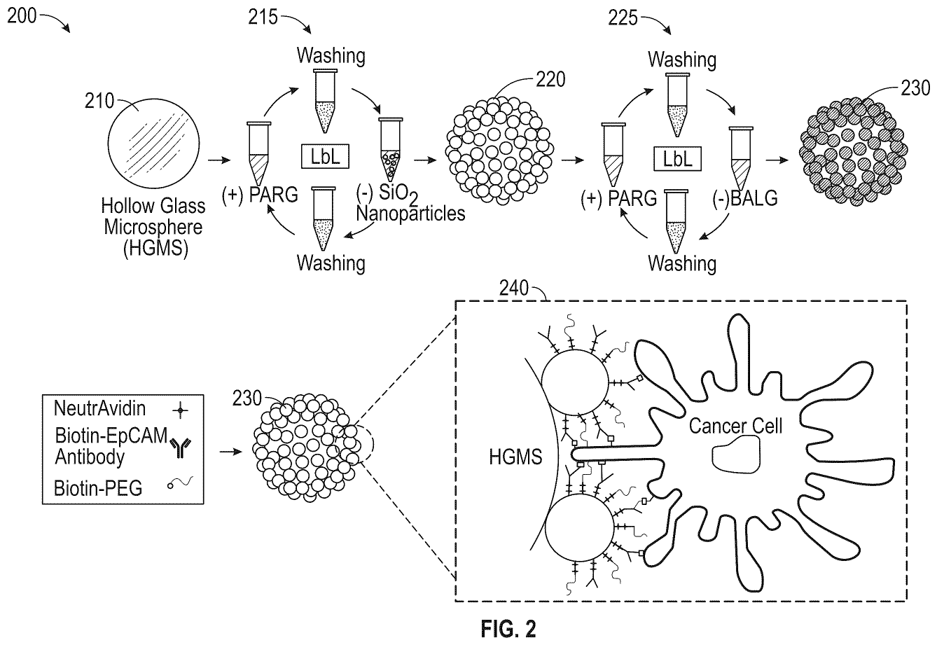

The detailed fabrication process of NSHGMS 200 is shown in FIG. 2. First, an HGMS 210 can be incubated in PARG and SiO₂ NP solutions alternatively to form nanotopographical structures on the surface of HGMS, as shown in step 215.

Then, the HGMS, coated with PARG and SiO₂ 220, can be coated with PARG and BALG as shown in step 225. This creates a degradable coating on the coated hollow microsphere. Finally at step 230 biotin molecules 230 are added for further functionalization. Next, the NSHGMS is conjugated with anti-EpCAM antibody and PEG molecules via the biotin-avidin interaction as shown in step 230. Finally, the NSHGMS is ready for cancer cell capture as shown by blown up surface details in box 240.

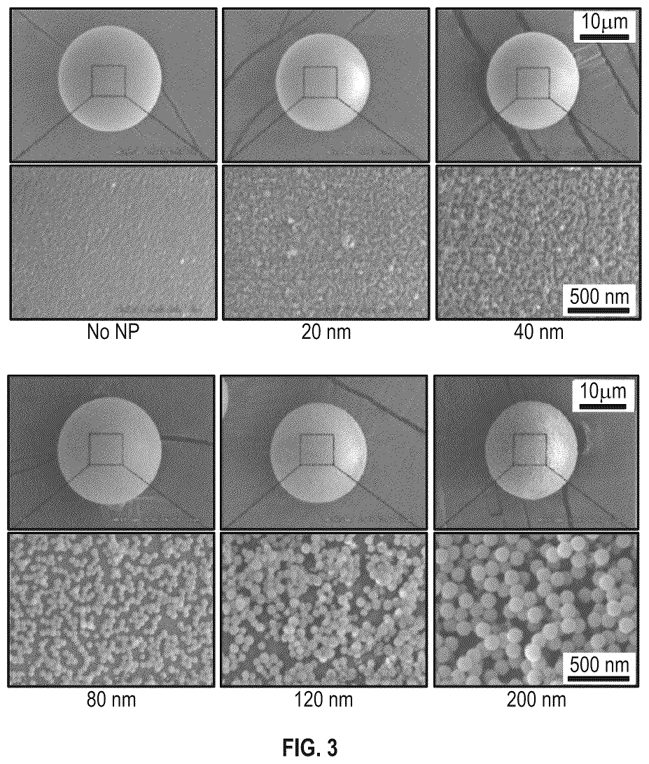

To illustrate the versatility of this method, five kinds of SiO₂ NPs with different diameters (20 nm, 40 nm, 80 nm, 120 nm, and 200 nm) were used to conduct the LbL deposition process. The resulting NSHGMS were examined by SEM as shown in FIG. 3. The surface of HGMS was covered by SiO₂ NPs with various sizes, using layer-by-layer (LbL) assembly process as follows: (a) no SiO₂, (b) 20 nm, (c) 40 nm, (d) 80 nm, (e) 120 nm and (f) 200 nm. The scale bar is 10 μm in the first and third rows, and 500 nm in the second and forth rows. The HGMS modified only with PARG/BALG polymers showed smooth surfaces, while SiO2 NP-modified NSHGMS presented rough surfaces. The enlarged views (2nd and 4th rows) clearly display the nanotopographical structures of deposited SiO₂ NPs. After two cycles of deposition, the surfaces of NSHGMS were uniformly covered by SiO₂ NPs. The nanoscale bumps and valleys formed on the surface of NSHGMS could facilitate the contact between the surface components of the targeted cancer cells and HGMS surfaces and provide more interaction sites for cell-HGMS bonding.

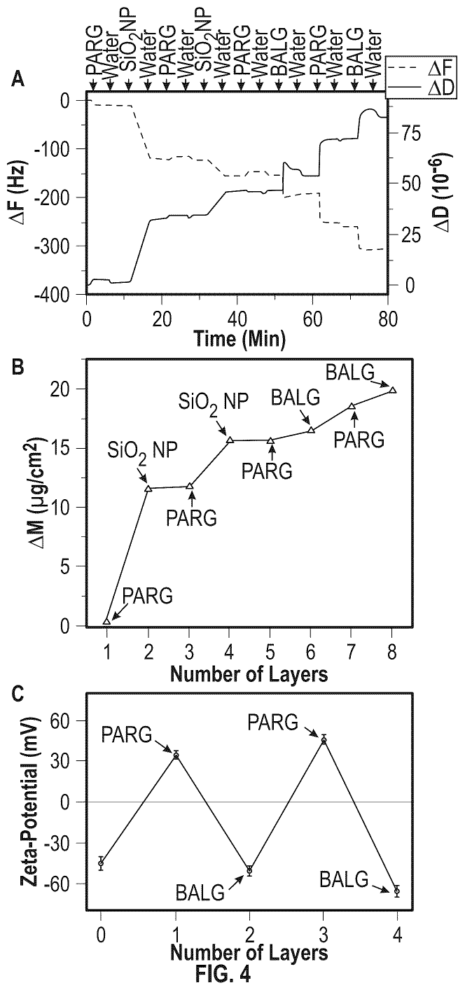

To best understand the LbL assembly process for creating nanotopographical structure on the surface of HGMS, QCM-D was used to monitor each of the material adsorption steps. In this experiment, a sensor placed in a QCM-D flow cell was put in contact with solutions in the same order as the LbL process for NSHGMS. As illustrated in FIG. 4, in QCM-D, the change of resonance frequency (F) represents the mass of adsorbed or bound materials while dissipation (D) indicates the viscoelastic stiffness of the attached molecules. The decreasing of F values suggests adsorption of molecules on the surface, while the increasing of D values implies attachment of softer molecules.

FIG. 4(a) illustrates a stepwise decrease of F value for the QCM sensor in the process of LbL assembly, indicating successful adsorption of designated material on the surface of the sensor. FIG. 4(b) shows the mass of the absorbed materials during each step, calculated using the change of F values from FIG. 4a. During the two adsorption steps of SiO₂ NPs (200 nm), mass additions of 13.3 μg/cm² and 3.8 μg/cm² were observed, which corresponded to 1.02*109 cm⁻² and 3.43*108 cm⁻² surface coverage of SiO₂ NPs, respectively. A total density of SiO₂ NPs covered on the surface of the QCM sensor was approximately 1.363*109 particles per cm². Considering the desorption of SiO₂ NPs off the surface of QCM sensor due to the constant shear stress applied on, this value maybe lower than the real coverage of SiO₂ NPs on the surface of NSHGMS. After deposition of SiO₂ NPs, adsorption of PARG and BALG molecules was repeated two times to form a thin multifunctional LbL film on the outmost surface of NSHGMS, which allows conjugation of antibody for cancer cell capture and biodegradation for cancer cell release. From the resonance frequency change shown in FIG. 4a, the mass of this [PARG/BALG] 2 film was approximately 4.2 μg/cm². Successful coating of the PARG/BALG film was also confirmed from alternation of surface zeta potential after adsorption oppositely charged polymers, as shown in FIG. 4(c). The values on the zeta-potential during LbL deposition were in good agreement with those from previous reported work. It is noted that the outmost surface was capped by BALG molecules.

To ensure noninvasive release of captured cancer cells and to preserve the viability of released cells, it is essential that the outmost antibody-embedded film quickly degrades under mild conditions. Also required is that the SiO₂ NPs beneath the PARG/BALG film should not peel off from the HGMS surface. Undesired peeling of SiO₂ NPs may be taken up by the cancer cells and cause cell apoptosis. Fluorescence microscopy and SEM were used to study degradation behavior of the PARG/BALG film on the surface of NSHGMS.

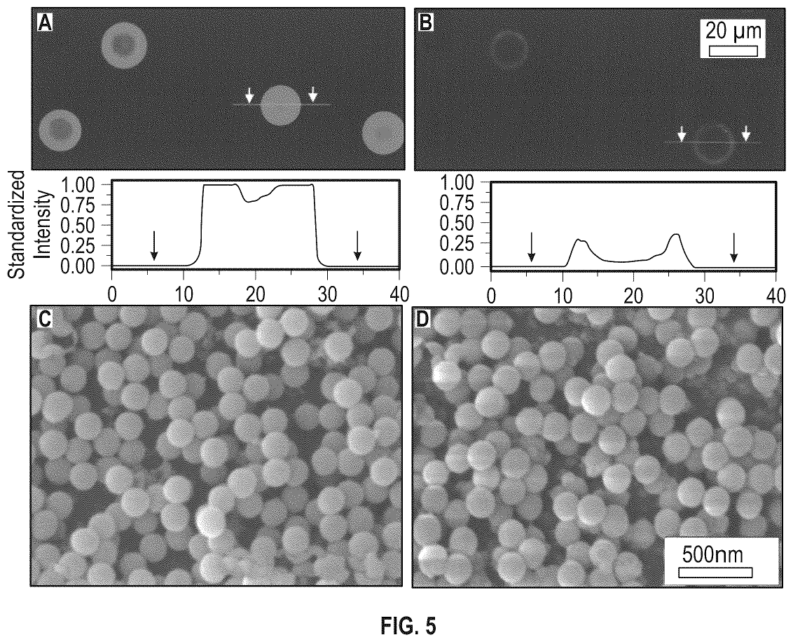

As shown in FIGS. 5(a) and 5(b), the degradation process was visualized by conjugating Texas Red labeled Neutravidin on the surface of NSHGMS. A strong fluorescence intensity was detected before degradation, indicating that the outermost layer of NSHGMS was covered with of the PARG/BALG film. After 10 min incubation with ALG lyase solution, an average 5 times lower fluorescent intensity was observed, suggesting a fast and effective deconstruction of the PARG/BALG film. In addition, SEM images, as shown in FIGS. 5(c) and 5(d), revealed similar surface nanostructures before and after degradation by ALG lyase, and no sign of SiO₂ NPs loss was observed. Standard intensity was quantified using image and the fluorescence intensity of NSHGMS before degradation was set to 1.0. The biotin groups on NSHGMS surface were tagged with Neutravidin-Texas Red. These two experiments confirmed that the outmost layer of the PARG/BALG film can be rapidly degraded, and its degradation does not change the nanotopographical structure on the surface of NSHGMS.

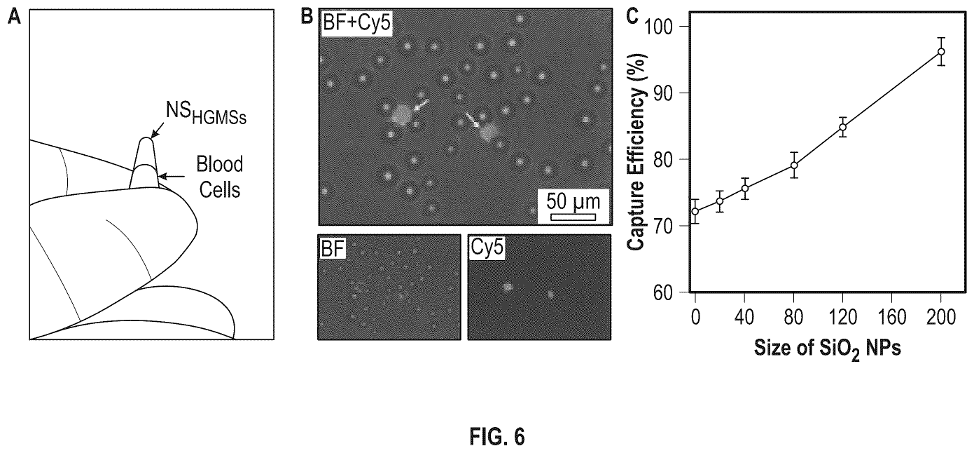

To evaluate the cancer cell isolation performance of NSHGMS, an EpCAM positive cell line, MCF7 (pre-stained by CellTracker™ Deep Red), was spiked in 5× diluted blood with 1,000 cells/mL and used in the experiment as a model system. The cancer cell spiked blood samples were incubated and rotated with NSHGMS in a tube for 1 hour to ensure sufficient contact between cells and NSHGMS. Afterwards, the blood samples stood for 5 minutes to allow NSHGMS to float to the tip of the collecting tube and the blood cells to settle to the lower half of the collecting tube, as shown in FIG. 6(a). NSHGMS (with captured cancer cells) were transferred into PDMS microwells, counted under fluorescent microscope, and a typical image is shown in FIG. 6(b). Cancer cells were all closely attached to 1-4 NSHGMS, and no free-floating cancer cells (i.e. not surrounding by NSHGMS) were observed. The capture efficiency of NSHGMS covered with SiO₂ NPs was compared at different sizes ranging from 20-200 nm. HGMS with smooth surface (no SiO₂ NP modification) showed 71.2±2.9% capture efficiency, which is consistent with our previous reported work. By creating nanotopographical structure on the surface of HGMS, cell capture efficiency of 73.7-94.8% was achieved, which also showed an increase trend with the increasing of the size of SiO₂ NPs that covered the surface, as shown in FIG. 6(c). NSHGMS covered with 20 nm SiO₂ NPs showing the largest contact surface indicated marginal increment of capture efficiency from 71.2±2.9% to 73.7±1.6%. This result indicated that increasing surface area alone may not be critical in enhancing cell capture efficiency. When NSHGMS were covered with 200 nm SiO₂ nanoparticles, the capture efficiency was dramatically improved to 94.8±2.2%: this can be attributed to the nanotopographical structures complementary to the filopodium on the cancer cells' surface. Filopodia of cancer cells are finger-like structures that let cells adhere and migrate on external substrates by aligning actin proteins to the points of contact. They are normally 100-300 nm in diameter and 1-3 μm in length. Compared to NsHGMS modified with smaller SiO₂ NPs, NSHGMS modified with 200 nm SiO₂ NPs may form gaps that fit and match the filopodia structure, enhancing shaft and tip adhesion of filopodia, resulting in higher capture efficiency. Similar findings have been reported where higher capture efficiency can be achieved by using a rough surface (150 nm) compared with less rough conditions. Additionally, an improved capture performance was observed by modifying a herringbone-structured microchip with 166 nm polystyrene NPs at a 22% surface coverage.

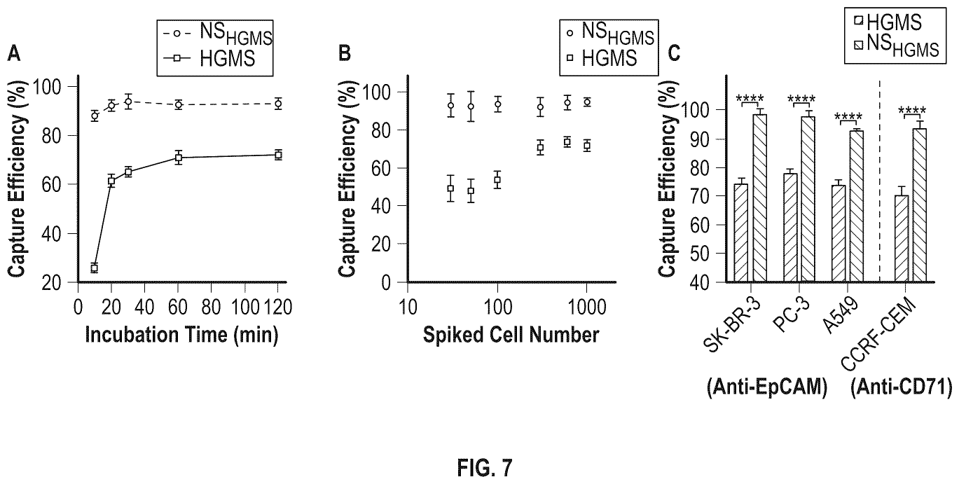

Processing time that allows sufficient cell capture can also be essential to preserve viable CTCs for clinical research. However, although a longer time period can enhance the chance of contact between cells and HGMS, viability of the captured cells may be compromised because a long incubation process could trigger apoptosis of CTCs. To evaluate the minimum time required to isolate high purity cancer cells, we examined capture efficiency at different incubation times, from 10 min to 120 min. As shown in FIG. 7a, maximum capture efficiency around 71.2±2.9% was observed after 60 min for HGMS with a smooth surface; as a comparison, maximum capture efficiency of 92.4±2.3% was observed in 20 min for NSHGMS modified with 200 nm SiO₂ NPs. This suggests that surface nanostructures of NSHGMS could accelerate the adhesion process of cancer cells.

FIG. 7 illustrates graphs of (a) capture efficiency of NSHGMS and regular HGMS at different incubation times, (b) capture efficiency of NSHGMS and regular HGMS with respect to various spiked cell concentrations (cell/mL), and (c) capture efficiency of NSHGMS and regular HGMS for different cancer cell lines (1,000 cells/mL). The number of CTCs in blood changes with the stages of cancer, with the detection range from a few to several hundred CTCs per milliliter of blood. Isolation of CTCs using smooth-surface HGMS has dramatically lower efficiency when cancer cell concentration is lower than 1,000 cells/mL. To evaluate the capability of NSHGMS on low-cell concentration, isolation of MCF7 with cell numbers ranging from 30 to 1000 cells/mL was studied, comparing them with experiments using regular HGMSs. As shown in FIG. 7(a), an average 93.6±4.9% of the capture efficiency was obtained for NSHGMS in these ranges and a decrease of cell concentration did not show significant reduction of capture efficiency. However, regular HGMS showed only 61.3±4.5% of capture efficiency in the same cell concentration range. Specifically, capture efficiency decreased to 47.8±7.6% for a cell concentration of 30 cells/mL. It was shown that invasive cancer cells often contain higher amount of filopodia, which express cell adhesion molecules for cell-cell adhesion, cell-extracellular matrix interaction, and probing of environment Compared with HGMS with smooth surface, the nanostructured surface of NSHGMS could fit the finger-like structure of filopodia and enhance both shaft and tip adhesion of filopodia. Adhesion sites formed at the shaft and at the tip are mediated by integrins and are thought to be critical to promote filopodium stability and to regulate filopodia growth. Recent evidence also demonstrated that filopodia shaft adhesions can mature into focal adhesions upon lamellipodia advancement. Therefore, nanostructures created by SiO₂ NPs could mediate faster adhesion and facilitate stronger binding between cancer cells and NSHGMS' surface. Furthermore, during the incubation process, cancer cells may undergo dynamic adhesion/disassociation circles with HGMS, and strong bonding between NSHGMS and cancer cells could reduce the disassociation rate of the captured cells. As a result, NSHGMS have demonstrated higher capture efficiency, lower detection limit, and shorter processing time.

Next, the application of NSHGMS was expanded to isolation of other human cancer cells. Similar experiments on capturing four other cell lines were performed, including A549 (a lung cancer cell line), PC-3 (a prostate cell line), SK-BR-3 (a breast cancer cell line), and CCRF-CEM (a leukemia cell line). Specifically, anti-EpCAM antibody was used to capture A549, PC-3 and SK-BR-3 cells, and anti-CD71 was used to capture CCRF-CEM cells. As shown in FIG. 7(c), NSHGMS achieved capture efficiencies of 92.7% to 98.5% for all 4 different cell lines. In contrast, only 72.2% to 77.8% capture efficiencies were observed for regular HGMS. These results demonstrate the constant and reliable cell recognition ability of NSHGMS.

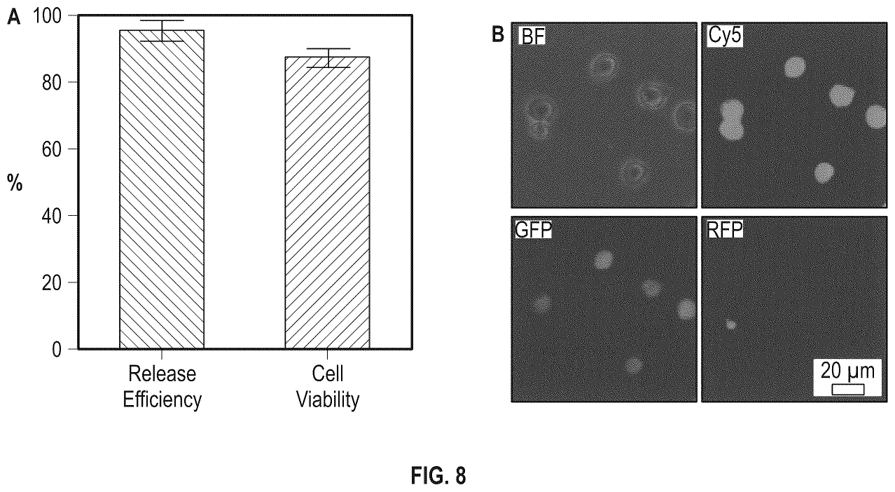

Finally, the release efficiency and viability of released cells was investigated. After 10 minutes of incubation with 1 mg/mL ALG lyase PBS solution, 95.3% of captured MCF7 cells were released from the surface of NSHGMS. FIG. 8(a) illustrates a graphical illustration of release efficiency and viability of released cancer cells from NSHGMS. These results were similar to the previously reported work using regular HGMS coated with PARG/BALG film, which suggested that nanotopographical structures on the surface do not affect the degradation behavior of the PARG/BALG film. Furthermore, viability of the released cells was quantified with a standard Live/Dead cell viability assay. FIG. 8(a) illustrates imaging of live (green)/Dead (red) staining of captured and released MCF7 cells. MCF7 cells were pre-stained with CellTracker™ Deep Red before spiking into blood (1000 cells/mL), where live MCF7 cells show co-localization of pink and green fluorescent signals. As shown in FIG. 8b, the majority of released cancer cells showed vivid green fluorescence. Quantitatively, cell viability was 87.2%, similar to the control cells that did not go through the capture and release process (90.2%). Both released cells and control cells were cultured on a tissue culture plate in a standard condition for an extended period, and no differences in cell adhesion and proliferation were observed between those two groups.

In summary, an LbL assembly method can be applied to tailor surface nanostructure and function of HGMSs for isolation of cells in fluid (e.g., blood or other bodily fluid), including rare cancer cells. Compared to HGMS with smooth surface, HGMS with nanotopographical structures exhibited excellent capture efficiency (93.6±4.9%), rapid processing time (20 min), and low detection limit (30 cells/mL) for commonly used human cancer cell lines. This is attributed to the nanostructure features on the HGMS surfaces and may be complementary to the filopodia on the surface of cancer cells, which mediate faster adhesion and facilitate stronger binding with cancer cells. This highly effective platform for cell isolation does not need specific lab apparatus or any power supplies, and can be combined with other portable diagnosis tools for point-of-care applications in remote and resource-deficient areas. Further, this work expanded the application of the LbL assembly method and provides a simple and effective strategy for creating nanostructures on non-planar substrates.

Additional embodiments can comprise multilayered nanofilm coated hollow glass microspheres (“functionalized HGMS”) for bacteria isolation and recovery. The embodiments can comprise functionalized HGMS which provide a simple isolation and recovery platform for rapid bacteria detection from food and bodily fluids without the need for sophisticated lab equipment.

Embodiments further include methods for isolation and recovery of bacteria such as Salmonella, from mixed bacterial populations in food matrixes. The method utilizes “functionalized” self-floating hollow glass microspheres coated with biodegradable layer-by-layer (LbL) films and bacteria specific antibodies. In certain embodiments of the method, the isolation and recovery process can be completed in less than two hours, without any sophisticated laboratory equipment or external force.

As an example, the disclosed methods and systems can be used for isolating and recovering bacteria such as Salmonella. Salmonella can be captured due to antigen-antibody interactions on the surface of HGMS, and the low density of the functionalized HGMS, which allows them to float to the top of a liquid carrier fluid. The HGMS can then be washed and subjected to enzymatic degradation of the LbL film to recover the captured bacteria. The recovered Salmonella can subsequently be grown on selective agar plates for further analysis. Recovery efficiency of up to 22% with detection limits of up to 100 CFU/ml can be achieved.

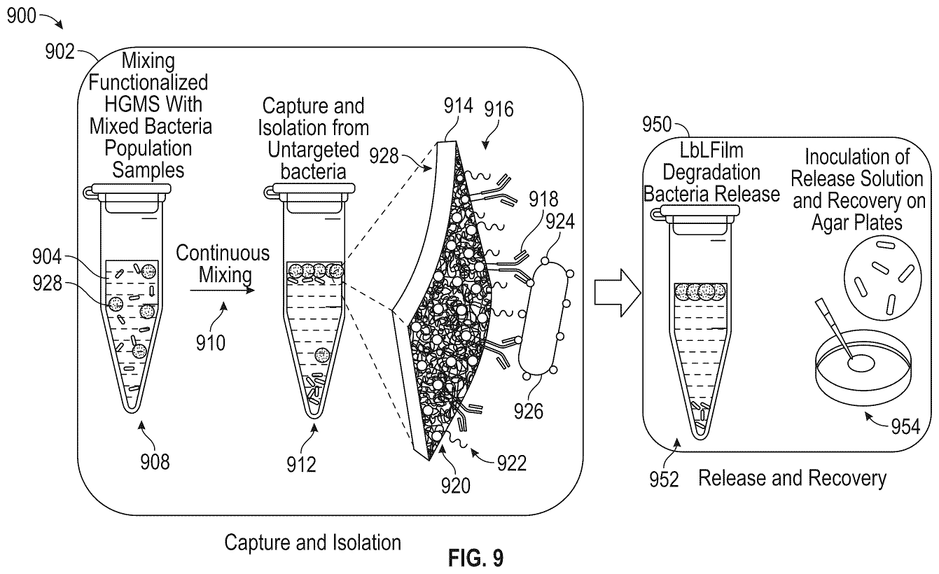

FIG. 9 illustrates steps associated with a method 900 for isolating and recovering bacteria. In the examples provided herein, Salmonella is used for illustrative purposes, but it should be appreciated that the embodiments may be extended to other bacteria in other embodiments.

The method 900 generally comprises a first capture and isolation step 902 and a second release and recovery step 950. It should be understood that there are numerous sub-steps associated with each of these basic steps as further detailed herein.

For the capture and isolation step 902, self-floating functionalized HGMS coated with layer-by-layer (LbL) polymeric nanofilms 928, which are conjugated with bacteria specific antibodies, are introduced to a bacterial suspension 904 at step 908. The bacterial suspension 904 can comprise a liquid carrier that has been populated with a sample taken from something suspected of having bacteria. As an example, a sample can be taken from meat, poultry, or produce suspected of being contaminated with Salmonella. The sample can be added to the carrier fluid.

Next at step 910 the bacterial suspension 904 is mixed with the functionalized HGMS. The bacteria (e.g. Salmonella) are captured due to interaction between antibodies on HGMS surface and the antigen on the surface of Salmonella as shown at 912.

Details of the constituent parts of the self-floating HGMS coated with layer-by-layer (LbL) polymeric nanofilms and conjugated with bacteria specific antibodies are illustrated in the exploded view in FIG. 9. Specifically, the HGMS 928 shell 914 is coated with layers of LbL polymeric film 916. Bacterial specific antibodies 918 are operably engaged with the coated surface. The coated surface can further include neutravidin 920 with antifouling polymers 922 extending therefrom. As illustrated, antigens 924 on the bacteria 926 interact with the antibodies 918, so that the bacteria is captured on the functionalized HGMS.

The HGMS with the captured bacteria float to the top of the suspension where it becomes simple to separate them from rest of the liquid suspension.

At step 950 the bacteria can be released and recovered. First, at step 952 the HGMS with the captured bacteria, which have been removed from the sample fluid, can be introduced to a solution with an enzyme. The enzyme solution leads to the non-invasive enzymatic degradation of the LbL polymeric nanofilms on the HGMS. As the LbL polymeric nanofilm degrades, the captured bacteria are released. In certain embodiments, alginate lyase can be used as the enzyme for degradation of the LbL nanofilm.

The released bacteria can then be cultured for further downstream analysis as illustrated at step 954.

The entire process 900 can take less than 2 hours for isolation and recovery of targeted bacteria serotypes, and much less than 24 hours for confirmation. In other embodiments, the method 900 can be coupled with next-generation sequencing for genomic profiling of targeted bacteria serotypes.

Testing has confirmed the efficacy of the method 900. Such testing has demonstrated isolation and recovery of Salmonella Typhimurium from various food and body fluid matrices such as phosphate buffer saline (PBS), beef, cantaloupe, and blood. Testing has further resulted in recovery of up to 22% and a detection limit of 100 CFU/mL.

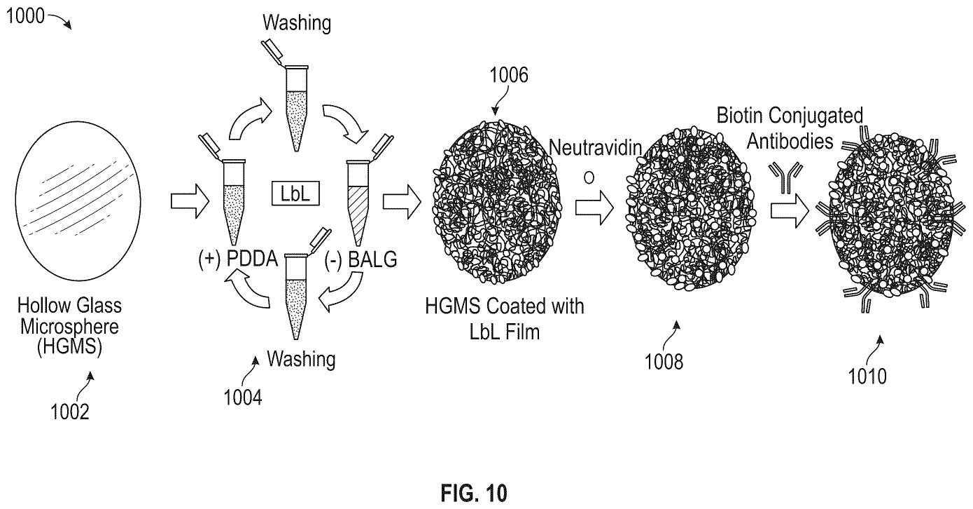

FIG. 10 illustrates a method 1000 for assembling a functionalized self-floating HGMS coated with layer-by-layer (LbL) polymeric nanofilms conjugated with bacteria specific antibodies. The method 1000 starts at step 1002 with one or more hollow glass microspheres. FIG. 10 illustrates the process of assembly for one HGMS, but it should be understood that the method can be applied to many HGMSs simultaneously.

In an exemplary embodiment, HGMS with an average diameter of 20 μm can be used for capture and isolation of bacteria since they have a density lower than aqueous mediums and therefore float to the surface. The diameter of the HGMS can be selected according to the biological particle they are being used to capture. Bacteria are exceedingly small so smaller diameter HGMS may be more effective for bacteria capture. HGMS are also used because they can be easily separated. In addition, glass provides a stable substrate with an inherent strong negative charge which makes it easy to coat with alternate positive and negatively charged LbL polymeric films.

At step 1004 a layer by layer deposition cycle of polymer is completed. At this stage negatively charged Polydiallyldimethylammonium chloride (PDDA) is dissolved in deionized water (pH 7) to a concentration of 2 mg/ml and subsequently pH adjusted to 5. The HGMS is placed in the PDDA solution. The HGMS is then sterilized with ethanol and washed with deionized water. The HGMS is then subjected to Biotin conjugated alginate (BALG), and then sterilized and washed in the same manner again. The deposition of polymers via the LbL cycle 1004 involves incubating HGMS with the PDDA and BALG polymers for example, for 10 minutes for the first bilayer and 5 minutes for each subsequent bilayer, totaling 5 bilayers, with the washing step with deionized water conducted in between each polymer deposition. It should be understood that in other embodiments, other numbers of layers may be deposited.

Step 1004 may further comprise a final application of SiO₂. The layer of SiO₂ can be deposited on the outermost layer of the polymer. The SiO₂ helps roughen the outer surface of the functionalized HGMS so that it is more receptive to the antibodies which will be bound to the surface. Other roughening agents may also be used. In certain embodiments, the step 1004 can also include the application of polyethylene glycol to help prevent non-specific binding of other undesirable antibodies. The polymer coated HGMS is illustrated as 1006.

PDDA is one viable positively charged polymer owing to its positively charged nature and proven biocompatibility. Alginate is a viable option as the negatively charged polymer since it is naturally derived, biocompatible, extensively used, can be enzymatically degraded with alginate lyase at ambient conditions, and can be easily modified with biotin conjugation through a carbodiimide reaction.

Step 1008 illustrates the introduction of neutravidin. Fluorescent neutravidin with Texas Red conjugation can optionally be introduced after LbL deposition to verify successful biotin conjugation and presence of biotin active sites on the HGMS surface introduced after LbL deposition.

Next at step 1010, biotinylated primary antibodies can be introduced for surface functionalization of the HGMS. The primary antibody can be selected according to the bacteria the system is being used to test for.

For example, if a sample is suspected of being contaminated with Salmonella, the coated functionalized HGMS can be introduced to a solution of Salmonella polyclonal antibodies to coat the functionalized surface. For applications testing lysed blood, a 1:1 concentration of Salmonella polyclonal antibody and poly (ethylene glycol) (PEG) can be used for HGMS surface functionalization to inhibit non-specific binding of blood cells which may lead to blocking of Salmonella binding sites. More generally, the specific antibody solution can be selected according to the specific application.

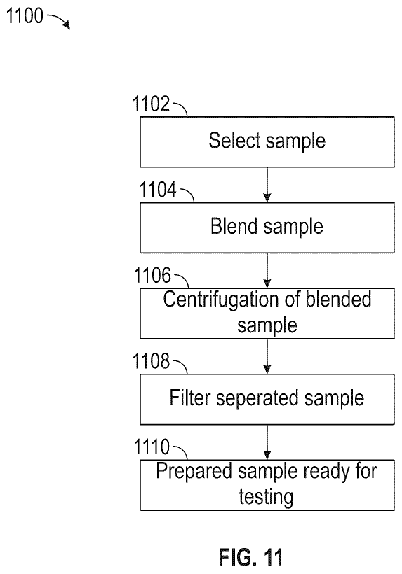

FIG. 11 illustrates steps associated with the method of selecting and preparing a sample for testing according to the methods, and with the systems, disclosed herein. At step 1102 a sample can be selected for testing. In an exemplary case, the sample could be a food product like beef or cantaloupe, suspected of being contaminated with a bacteria like salmonella.

At step 1104, the sample can optionally be blended or pureed into a fluidic state. This step is optional because if the sample is already in such a state blending is not necessary. For example, if beef from a particular facility is suspected of being contaminated with Salmonella, some of the beef can be selected as the sample and blended into a fluidic state.

Next at step 1106 the blended sample can be separated. This can be accomplished by centrifugation, or other such methods. The separated sample can then be filtered at step 1108, at which point the sample is ready for testing usings the functionalized HGMS as detailed herein.

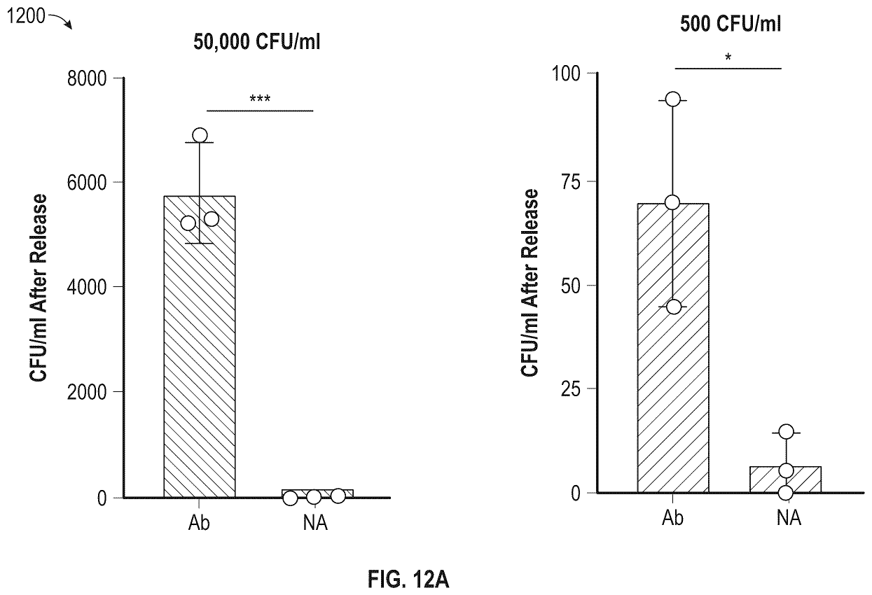

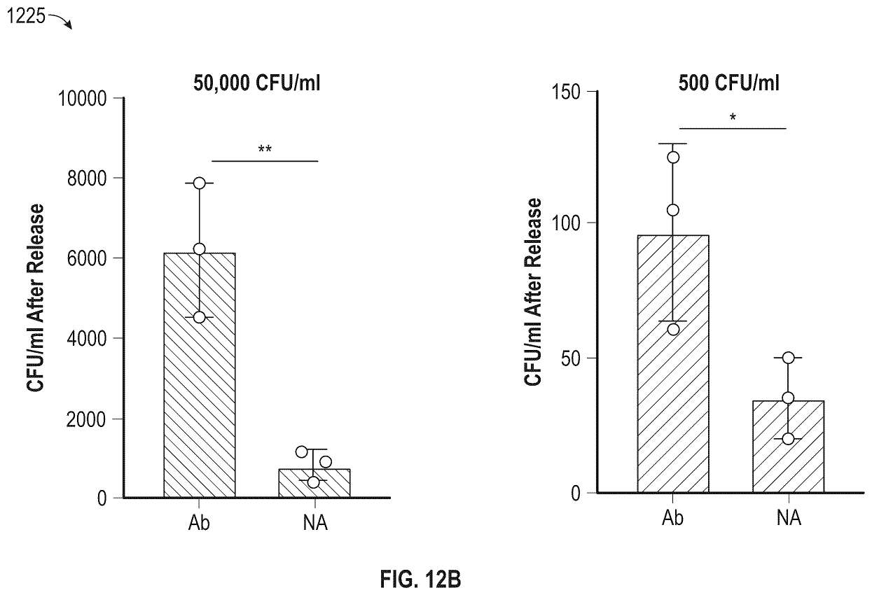

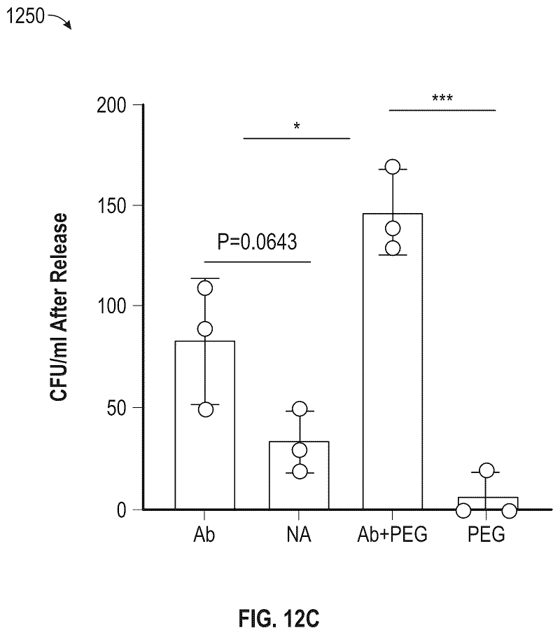

The efficacy of the disclosed systems and methods have been verified with testing. FIG. 12A-FIG. 12C illustrate capture and recovery of Salmonella in spiked food and blood samples. Specifically, FIG. 12A provides a chart 1200 showing capture efficiency in Salmonella spiked beef extract at 50,000 and 500 CFU/ml using the disclosed functionalized HGMS according to the methods disclosed herein. FIG. 12B provides chart 1225 showing capture efficiency in Salmonella spiked cantaloupe at 50,000 and 500 CFU/ml using the disclosed functionalized HGMS according to the methods disclosed herein. FIG. 12C provides a chart 1250 showing capture efficiency in Salmonella spiked lysed blood with and without a PEG antifouling layer at 1,000 CFU/ml (***p<0.001, **p<0.01, *p<0.05 and NS p>0.05), using the disclosed functionalized HGMS according to the methods disclosed herein.

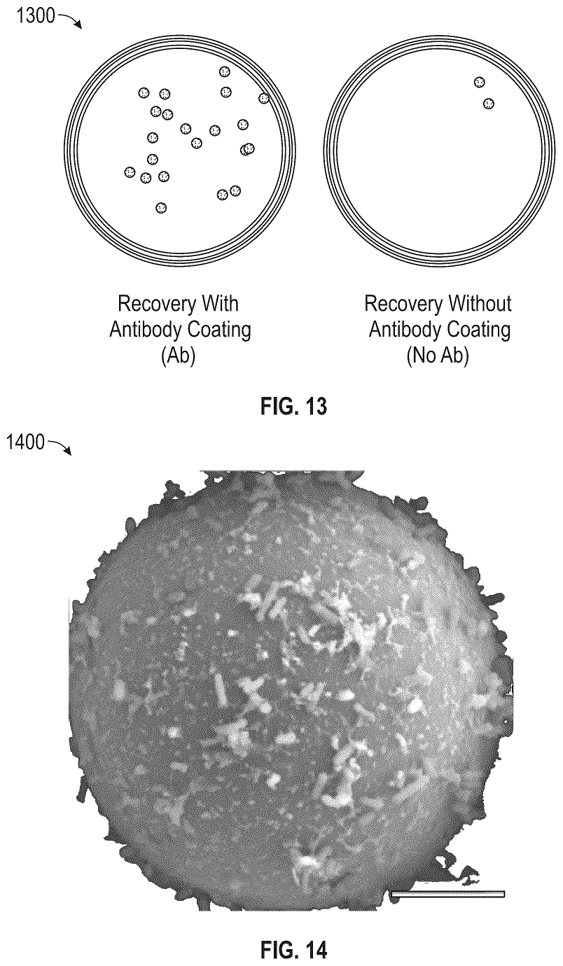

FIG. 13 includes an image 1300 of colony formation 20 hours after Salmonella recovery with and without antibody functionalization. As the image shows, recovery with the antibody coating is significantly better than without the antibody coating.

FIG. 14 illustrates an SEM image of a pseudo-colored Salmonella (rod-shaped structured) captured on the disclosed functionalized HGMS surface.

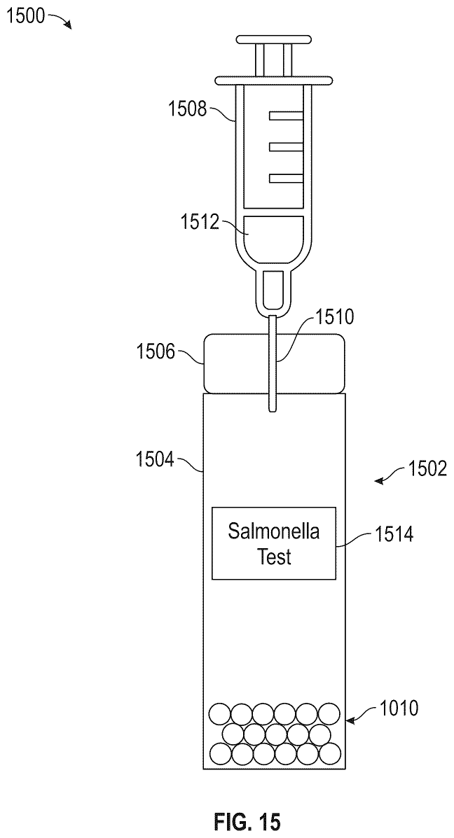

FIG. 15 illustrates an integrated testing system 1500 in accordance with the disclosed embodiments. The system generally comprises a testing tube 1502 comprising an uncharged glass or plastic tube 1504, with a rubber stopper 1506. The tube can have a set of pre-prepared functionalized HGMS (such as functionalized HGMS 1010) therein. The pre-prepared functionalized HGMS 1010 can be selected for any suspected bacterial contamination. For example, some tubes could have functionalized HGMS with antibodies for Salmonella, while others could have functionalized HGMS with antibodies for E-coli, and so forth. A label 1514 can be provided on the tube 1504 to identify the contaminant for which the functionalized HGMS in the tube 1504 is configured to test.

In practice, the testing tube 1502 can be taken to the field, where an agent may be taking samples. The agent can prepare a sample 1512 of a biological particle suspected of being contaminated (e.g. a sample of meat or produce), and prepare the sample for testing (for example as outlined in method 1100). The agent can then draw the sample into a syringe 1508 and use the needle 1510 to puncture the rubber stopper 1506 and deposit the sample 1512 into the testing tube 1502. The testing tube 1502 can be shaken or mixed and then sent to a lab for biological particle recovery from the sample according to the methods disclosed herein.

Embodiments are directed to an LbL nanofilm and antibody-coated self-floating HGMS configured for rapid isolation and recovery of bacteria, using Salmonella Typhimurium as the model organism. The testing process for isolation and recovery using the systems and methods disclosed herein can be completed in under two hours and offer a detection limit of 100 CFU/mL in PBS. Moreover, the disclosed systems and methods can be used for bacteria separation and recovery in spiked food and blood samples at a 200 CFU/mL detection limit, which suggests the use of these systems and methods can be extended to clinical applications.

It should be understood that in certain examples, the isolation and recovery of Salmonella Typhimurium is used as a model system. However, embodiments can be extended for detection of various bacterial populations that have a significant impact on public health, such as other Salmonella serotypes (e.g., Enteritidis, Heidelberg and Newport) or other bacterial species including but not limited to shigella-toxin producing E. Coli and Pseudomonas. Other such embodiments require the use of corresponding antibodies on the HGMS surface. In addition, embodiments can be readily integrated with molecular techniques such as PCR, Q-PCR and next generation sequencing, for further isolate characterization.

Based on the foregoing, it can be appreciated that a number of embodiments, preferred and alternative, are disclosed herein. For example, an embodiment includes a method for capturing and separating biological particles comprising exposing a plurality of functionalized microspheres to a fluidic sample with a suspected biological particle, capturing biological particles on the functionalized microspheres, removing the functionalized microspheres from the fluidic sample, and releasing the captured biological particles from the functionalized microspheres. The functionalized microspheres comprise hollow glass microspheres coated with at least two layers of charged polymeric nanofilms and a plurality of biotinylated antibodies operably connected to an outer layer of the at least two layers of charged polymeric nanofilm. One of the at least two layers of polymeric nanofilm comprises positively negatively biotin modified alginate and one of the at least two layers of polymeric nanofilm comprises positively charged Polydiallyldimethylammonium chloride. In an embodiment, the suspected biological particle comprises a suspected bacterial contaminant. In an embodiment, the biotinylated antibodies are antibodies for the suspected bacterial contaminant. In an embodiment, releasing the biological particle from the functionalized microspheres comprises exposing the functionalized microspheres with the captured biological particles to an enzyme selected to degrade the polymeric nanofilm. In an embodiment, the enzyme comprises alginate lyase. The method can include collecting the released biological particle after releasing the captured biological particle from the functionalized microspheres. In an embodiment, the method includes identifying the released biological particle after releasing the captured biological particle from the functionalized microspheres.

Another embodiment includes a system for capturing and separating biological particles comprising a plurality of microspheres, at least two layers of polymeric nanofilm deposited on each of the plurality of microspheres, the first layer of the at least two layers of polymeric nanofilm comprising a coating of positively charged polymeric nanofilm; and the next layer of the at least two layers of polymeric nanofilm comprising a coating of negatively charged polymeric nanofilm, and a plurality of biotinylated antibodies functionally bound to an outer layer of the at least two layers of polymeric nanofilm. In an embodiment, the coating of positively charged polymeric nanofilm comprises positively charged Polydiallyldimethylammonium chloride. In an embodiment, the coating of negatively charged polymeric nanofilm comprises negatively charged biotin modified alginate. In an embodiment, the plurality of biotinylated antibodies are antibodies for a suspected bacterial contaminant. In an embodiment, the system further comprises an enzyme configured to degrade the polymeric nanofilm deposited on each of the plurality of microspheres. In an embodiment the enzyme comprises alginate lyase. In an embodiment, each of the plurality of microspheres comprise a negatively charged hollow glass microspheres.

Another embodiment includes a method of making a system for capturing and separating biological particles comprising exposing a plurality of hollow glass microspheres to a layer by layer deposition cycle of charged polymeric nanofilms to form a plurality of coated hollow glass microspheres and functionally binding a plurality of biotinylated antibodies to the plurality of coated hollow glass microspheres. In an embodiment the layer by layer deposition cycle of charged polymeric nanofilms comprises exposing the plurality of hollow glass microspheres to a positively charged Polydiallyldimethylammonium chloride, washing the plurality hollow glass microspheres, exposing the plurality of hollow glass microspheres to a negatively charged biotin modified alginate, and washing the hollow glass microspheres. The layer by layer deposition cycle of charged polymeric nanofilms further comprises exposing the plurality of hollow glass microspheres to the first positively charged Polydiallyldimethylammonium chloride for at least 10 minutes and exposing the plurality of hollow glass microspheres to all subsequent layers of the charged polymeric nanofilms for at least 5 minutes. In an embodiment, the plurality of biotinylated antibodies comprise antibodies for a suspected bacterial contaminant.

It will be appreciated that variations of the above-disclosed and other features and functions, or alternatives thereof, may be desirably combined into many other different systems or applications. Also, it should be understood that various presently unforeseen or unanticipated alternatives, modifications, variations or improvements therein may be subsequently made by those skilled in the art which are also intended to be encompassed by the following claims.

What is claimed is:

1. A method for capturing and separating biological particles comprising:
exposing a plurality of functionalized microspheres to a fluidic sample with a suspected biological particle;
capturing biological particles on the functionalized microspheres;
removing the functionalized microspheres from the fluidic sample; and
releasing the captured biological particles from the plurality of functionalized microspheres.

2. The method for capturing and separating biological particles of claim 1 wherein the plurality of functionalized microspheres comprise:
hollow glass microspheres coated with at least two layers of charged polymeric nanofilms; and
a plurality of biotinylated antibodies operably connected to an outer layer of the at least two layers of charged polymeric nanofilm.

3. The method for capturing and separating biological particles of claim 2 wherein the plurality biotinylated antibodies are antibodies for the suspected biological particle comprising a suspected bacterial contaminant.

4. The method for capturing and separating biological particles of claim 2 wherein one of the at least two layers of polymeric nanofilm comprises:
negatively charged biotin modified alginate; and
wherein one of the at least two layers of polymeric nanofilm comprises:
positively charged Polydiallyldimethylammonium chloride.

5. The method for capturing and separating biological particles of claim 2 wherein releasing the captured biological particles from the functionalized microspheres comprises:
exposing the plurality of functionalized microspheres with the captured biological particles to an enzyme selected to degrade the polymeric nanofilm.

6. The method for capturing and separating biological particles of claim 5 wherein the enzyme comprises alginate lyase.

7. The method for capturing and separating biological particles of claim 1 wherein the suspected biological particle comprises a suspected bacterial contaminant.

8. The method for capturing and separating biological particles of claim 1 further comprising:
collecting the released biological particle after releasing the captured biological particles from the plurality of functionalized microspheres.

9. The method for capturing and separating biological particles of claim 1 further comprising:
identifying the released biological particle after releasing the captured biological particle from the plurality of functionalized microspheres.

10. A system for capturing and separating biological particles comprising:
a plurality of microspheres;
at least two layers of polymeric nanofilm deposited on each of the plurality of microspheres, the first layer of the at least two layers of polymeric nanofilm comprising a coating of positively charged polymeric nanofilm; and a next layer of the at least two layers of polymeric nanofilm comprising a coating of negatively charged polymeric nanofilm; and
a plurality of biotinylated antibodies functionally bound to an outer layer of the at least two layers of polymeric nanofilm.

11. The system for capturing and separating biological particles of claim 10 wherein the coating of positively charged polymeric nanofilm comprises:
positively charged Polydiallyldimethylammonium chloride.

12. The system for capturing and separating biological particles of claim 10 wherein the coating of negatively charged polymeric nanofilm comprises:
negatively charged biotin modified alginate.

13. The system for capturing biological particles for capturing biological particles of claim 10 wherein the plurality of biotinylated antibodies are antibodies for a suspected bacterial contaminant.

14. The system for capturing and separating biological particles of claim 10 further comprising:
an enzyme configured to degrade the polymeric nanofilm deposited on each of the plurality of microspheres.

15. The system for capturing and separating biological particles of claim 14 wherein the enzyme comprises alginate lyase.

16. The system for capturing and separating biological particles of claim 14 wherein each of the plurality of microspheres comprise:
a negatively charged hollow glass microsphere.

17. A method of making a system for capturing and separating biological particles comprising:
exposing a plurality of hollow glass microspheres to a layer by layer deposition cycle of charged polymeric nanofilms to form a plurality of coated hollow glass microspheres; and
functionally binding a plurality of biotinylated antibodies to the plurality of coated hollow glass microspheres.

18. The method of making a system for capturing and separating biological particles of claim 17 wherein layer by layer deposition cycle of charged polymeric nanofilms comprises:
exposing the plurality of hollow glass microspheres to a positively charged Polydiallyldimethylammonium chloride;
washing the plurality of hollow glass microspheres;
exposing the plurality of hollow glass microspheres to a negatively charged biotin modified alginate; and
washing the hollow glass microspheres.

19. The method of making a system for capturing and separating biological particles of claim 18 wherein the layer by layer deposition cycle of charged polymeric nanofilms further comprises:
exposing the plurality of hollow glass microspheres to the first positively charged Polydiallyldimethylammonium chloride for at least 10 minutes; and
exposing the plurality of hollow glass microspheres to all subsequent layers of the charged polymeric nanofilms for at least 5 minutes.

20. The method of making a system for capturing and separating biological particles of claim 17 wherein the plurality of biotinylated antibodies comprise:
antibodies for a suspected bacterial contaminant.
